(19) United States
(12) Patent Application Publication
(10) Pub. No.: US 2003/0181159 A1
(43) Pub. Date: Sep. 25, 2003

(54) Combination of multiple regional beams and a wide-area beam provided by a satellite system

(76) Inventors: Paul Heinerscheid, St. Paul, MN (US); George Nawar, Ottawa (CA); Jean-Marc Villevieille, Phoenix, AZ (US); Ali Shoamanesh, Ottawa (CA)

Correspondence Address: John Morrish, Global Radio, SA, 33 Parc d'Activite Syrdall, L-5365 Munsbach, Luxembourg, BE

(21) Appl. No.: 10/102,914

(22) Filed: Mar. 22, 2002

(51) Int. Cl. H04H 1/00

(52) U.S. Cl. 455/3.02; 455/12.1

(57) ABSTRACT

A coverage area for a satellite digital audio broadcasting system is generated using a wide-area beam and at least three other beams. The other beams each have a coverage area that overlaps the coverage area of the wide-area beam. The beams may be generated by a plurality of satellites traveling in highly elliptical orbits. A frequency spectrum including four or more frequency blocks of approximately 1.5 MHz each may be used to transmit media content from the satellites on the beams. The multi-beam system can provide a content distribution blend tailored to specific regions while providing multi-regional content through out the coverage area. For example, the system provides a content distribution blend tailored to regional diversity of Europe through regional beams while providing European “country agnostic” or “supra-national” content to all users through the wide-area beam.

### FIELD OF THE INVENTION

The invention is generally related to satellites. More particularly, the invention is related to a communication satellite coverage area provided by multiple satellite beams.

### BACKGROUND OF THE INVENTION

Communications satellites are often used as relay stations. One use of a communication satellite includes the re-broadcast of media content, such as radio or television programming, from a service provider. One approach to transmission of radio programming is digital audio broadcasting (“DAB”), which attempts to provide radio programming free from interference or distortion caused by mountains, high-rise buildings, weather conditions, etc. Besides audio signals, DAB may also transmit text, still data, images and narrow-band video.

The World Administrative Radio Conference (WARC), which took place in 1992 (WARC'92), allocated 40 MHz (1452-1492 MHz) in the L-Band for DAB on a worldwide basis, except for the United States which chose the 2.3 GHz band for its Satellite Digital Audio Radio Service (S-DARS). Since 1992, it was agreed that the 40 MHz band allocated by the WARC can accommodate twenty-three frequency blocks of 1536 kHz each.

FIG. 6 illustrates the 40 MHz frequency band 600 allocated for DAB. Of the band 600, the lower nine frequency blocks 1-9, labeled as a group 610, were allocated for various administrations in Europe. The remaining fourteen frequency blocks 10-23, labeled as a group 620, may be used by private companies to provide DAB services.

Due to the limited available bandwidth in Europe, as well as the United States, the allocation of the frequency blocks for transmission of DAB media content is a critical design factor in the design of a DAB system. In other words, the frequency blocks should be allocated to support the channels provided by the DAB service provicer.

In addition to frequency allocation, coverage area of a DAB system is another critical design factor for a DAB system. The coverage area defines an area that may receive information (e.g., DAB channels) from a satellite. The coverage area is generally determined by a beam generated from the satellite that carries the information to Earth. Users within the beam receive the transmitted information. Gaps in the coverage area may be closed and the coverage area may be expanded by using repeaters strategically placed in the coverage area.

Conventional DAB satellite systems in the United States use a single beam to transmit radio programming to Earth, and thus generally provide a significantly limited variety of programming to the entire coverage area. XM® and Sirius® are exemplary satellite systems that provide media content programming in the United States. These systems have opted for a single beam divided into various frequency slots, but, in essence, broadcast the same amount of programs (e.g., approximately 100 channels) everywhere in the United States.

Conventional DAB satellite systems outside the United States (e.g., WorldSpace® and its Afristar® satellites) may broadcast three beams to provide a continental coverage area. The coverage area includes North Africa, Europe, the Middle East, and the southern part of Africa. AsiaStar and Ameristar also broadcast three beams to provide coverage for Asia and South America\Central America, respectively. These three-beam systems may include at least two beams that overlap. However, the overlap is typically de minimis and not by design. Furthermore, these systems generally utilize only wide-area beams providing coverage over large geographic areas spanning across entire continents and encompassing many countries. Therefore, these systems essentially amount to having three independent DAB systems on one satellite and are not conducive to providing a variety of localized programming within a continental area. Furthermore, multi-lingual and multi-cultural programming may be needed within such large geographic areas. The above-mentioned systems may not be able to provide or tailor the variety of multi-lingual and multi-cultural programming desired by the users.

Table 1 below illustrates the number of channels that may be provided by conventional DAB systems.

TABLE 1
Channels Generated From Conventional Systems

| | Main | | | |
|---|---|---|---|---|
| | Beam | Beam #2 | Beam #3 | Total |
| XM (U.S.) | 100 | | | 109 |
| SIRIUS (U.S.) | 100 | | | 100 |
| WoldSpace | 31 | 37 | 101 | |
| (Mid-East, Africa, Asia) | | | | |

The single beam systems in the United States may provide a maximum of 95-100 channels. The multi-beam systems, although using more than one beam, may be limited to approximately 101 channels. Therefore, the number of channels and variety of programming that is available to users of conventional DAB systems is significantly limited.

### SUMMARY OF THE INVENTION

An embodiment of the invention includes a digital audio broadcasting satellite system coverage area comprising a wide-area beam providing a wide-area coverage area. At least three other beams provide a coverage area overlapping the wide-area beam coverage area. Each of the three beams provides distinct media content to distinct regions within the system coverage area.

Another embodiment of the invention includes a digital audio broadcasting satellite system having a system coverage area. The system comprises a plurality of satellites traveling in highly elliptical orbits. The plurality of satellites include at least one satellite transmitting a wide-area beam including media content. The wide-area beam provides a wide-area coverage area. At least one satellite transmits at least three other beams, and each of the at least three beams provides a coverage area overlapping the wide-area beam coverage area. Each of the three beams provides distinct media content to distinct regions within the system coverage area. A plurality of repeaters receives the media content from the plurality of satellites and transmits the media content in the system coverage area. A plurality of receivers receives the media content from one or more of at least one of the plurality of satellites and at least one of the plurality of repeaters.

Yet another embodiment of the invention includes a method of generating a system coverage area for a digital audio broadcasting satellite system. The method comprises steps of selecting a frequency spectrum for transmitting media content from a plurality of satellites; transmitting a wide-area beam providing a wide-area coverage area; and transmitting at least three beams. Each of the at least three beams provides a coverage area overlapping the wide-area beam coverage area, and each of the three beams provides distinct media content to distinct regions within the system coverage area.

Yet another embodiment of the invention includes a digital audio broadcasting satellite system comprising a plurality of satellites. At least one of the plurality of satellites transmits a first beam providing media content to a first geographical area, and at least one of the plurality of satellites transmits at least one second beam to an at least one second geographical area. The at least one second beam provides media content distinct from the media content provided from the first beam, and the at least one second geographical area overlaps the first geographical area.

In comparison to known prior art, certain embodiments of the invention are capable of achieving certain aspects, including improved regional programming and a global increase in the amount of relevant programming content available to individual users. Those skilled in the art will appreciate these and other aspects of various embodiments of the invention upon reading the following detailed description of a preferred embodiment with reference to the below-listed drawings.

### BRIEF DESCRIPTION OF THE DRAWINGS

The invention is illustrated by way of example and not limitation in the accompanying figures in which like numeral references refer to like elements, and wherein:

FIG. 1 illustrates an exemplary system according to an embodiment of the invention;

FIG. 2 illustrates an exemplary frequency spectrum which may be used by an embodiment of the invention;

FIGS. 3a-b illustrates an exemplary multi-beam footprint according to an embodiment of the invention;

FIG. 4 illustrates an exemplary frequency re-use scheme that me be employed by an embodiment of the invention;

FIG. 5 illustrates a flow chart of an exemplary method according to an embodiment of the invention; and

FIG. 6 illustrates a frequency spectrum allocated for DAB.

### DETAILED DESCRIPTION OF THE INVENTION

In the following detailed description, numerous specific details are set forth in order to provide a thorough understanding of the invention. However, it will be apparent to one of ordinary skill in the art that these specific details need not be used to practice the invention. In other instances, well known structures, interfaces, and processes have not been shown in detail in order not to unnecessarily obscure the invention.

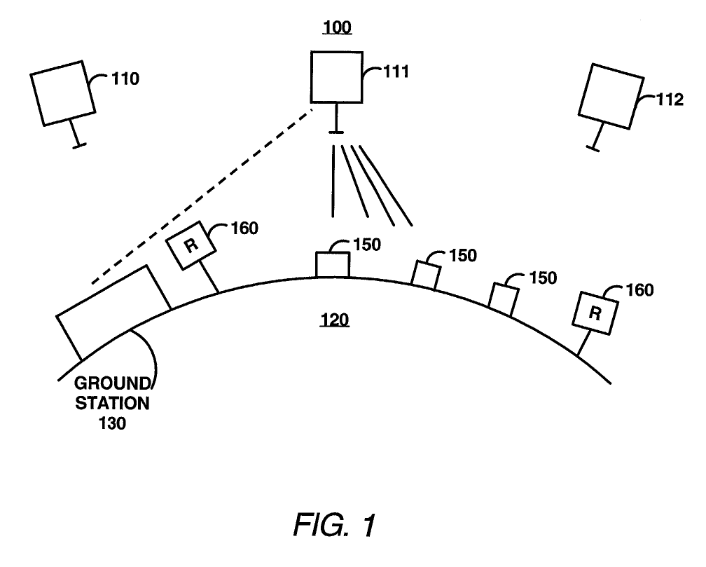

FIG. 1 illustrates an exemplary satellite system 100 employing principles of the invention. A plurality of satellites 110-112 orbit the Earth 120. The satellites 110-112 rebroadcast media content to the Earth 120. The satellites 110-112 may receive the media content from a ground station 130 and transmit the media content to a coverage area on the Earth 120 using one or more satellites beams. For example, the satellite 111 receives media content from the ground station 130 and transmits the media content to multiple receivers 150 in the coverage area using one or more beams 140. Multiple repeaters 160 on the Earth 120 may be used to increase signal strength and quality and to expand the coverage area. The number of satellites used in the system 100 may vary (e.g., one or a plurality) based on a variety of factors, including but not limited to, the intended coverage area and the number of beams needed to transmit the media content.

In one embodiment, the satellites 110-112 provide DAB media content to users on the Earth 120. The DAB media content primarily includes audio content provided on a plurality of channels to users. The DAB media content may also include text, data, images, video, etc.

The satellites 110-112 may utilize one of a variety of orbiting schemes to provide the necessary coverage. In another embodiment, the satellites 110-112 travel in highly elliptical orbits (HEOs), such as described in U.S. Provisional Application Ser No. ______ (TBD) (Attorney Docket No. 319345.0005), entitled A Highly Elliptical Orbit For Communication Satellites, herein incorporated by reference. The HEO orbit may be a lower inclination variation of a tundra orbit having a teardrop shaped ground track and an inclination approximately between 53 degrees and 56 degrees. The satellite following the lower inclination HEO orbit may be a part of a satellite constellation (e.g., satellites 110-112 may form a satellite constellation). The satellite constellation may include a three-satellite or a six-satellite constellation. For example, the satellite constellation may be initially implemented as a three-satellite constellation, and three more satellites may be launched later to form a six-satellite constellation. Multiple satellite constellations may also be used.

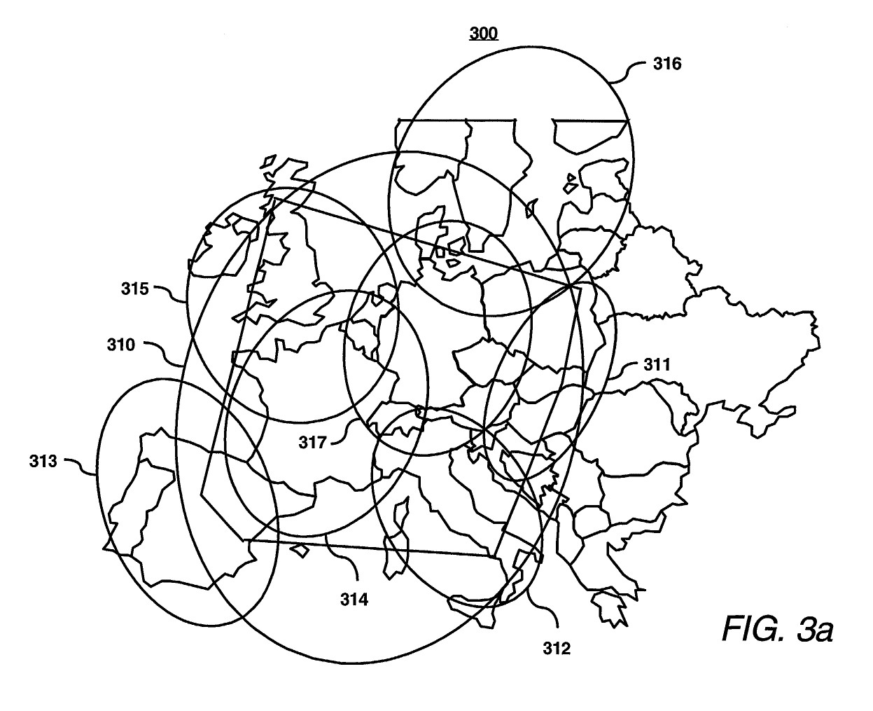

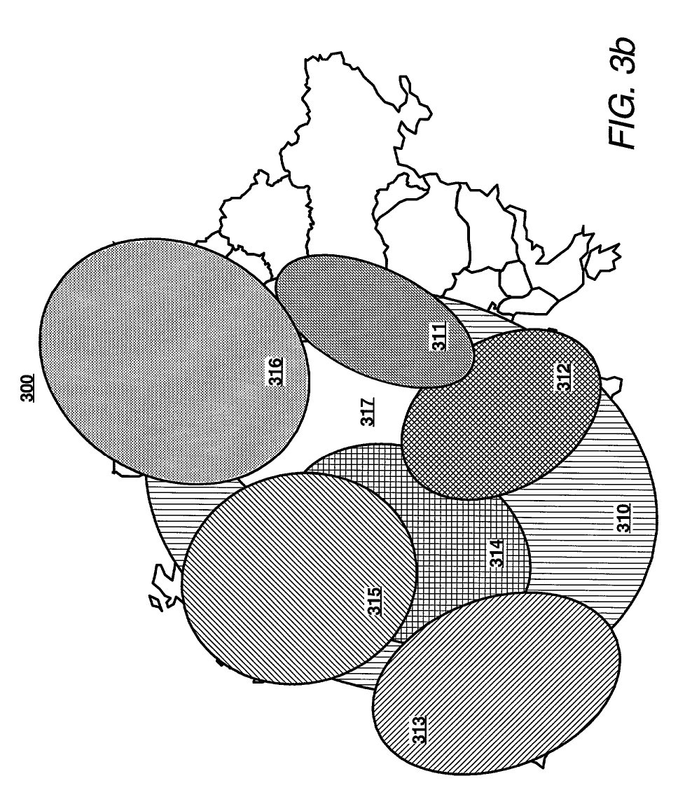

In one embodiment, multiple overlapping beams are used to transmit DAB media content to users. For example, a combination of single wide-area beam and multiple overlapping beams are used to maximize content reception channels and programming count per regions, as described in detail below with respect to FIG. 3. For example, the wide-area beam may provide general programming and each overlapping beam may provide additional programming of specific interest (e.g., regional programming).

DAB media content can be provided by the closest satellite traveling in an HEO. For example, a satellite coming over the horizon from the East can provide the Eastern beams, while another satellite may provide one or more of the remaining overlapping beams. This allows optimization of the elevation angle by selecting the best satellite to provide the coverage and power sharing between satellites, thereby allowing a reduction in the peak sizing of the spacecraft power handling capability.

The multiple regional beams can perform a “hand-over” between subsequent satellites at an elevation optimal for each region. For beam forming flexibility, a separate smaller antenna reflector is preferred for the large pan-European beam, and antenna beam forming technology with 12-meter reflector may be used for spot regional beams. Each beam may carry one or more DAB program ensembles also known as “multiplexes”. These ensembles occupy approximately 1.5 MHz of bandwidth and carry approximately 2.4 Mbits of information per second. The satellites 110-112 act as a traditional bent-pipe where the ground station 130 uplinks the totality of all DAB ensembles at the Ku band. The satellites 110-112 convert into L-band and assign the ensembles to the correct beam. From a resource management view point, 7-10 multiplexes may be sent through the Ku band uplink for each beam to simplify routing and avoid costly de-multiplexing and routing in orbit. The receiver (s) on board the satellite has access to the full multiplex and extracts the specific channel as selected by the user. Although the preferred embodiment uses HEOs, other orbiting schemes may be used, such as static geostationary elliptical orbits (GEOs), and the like.

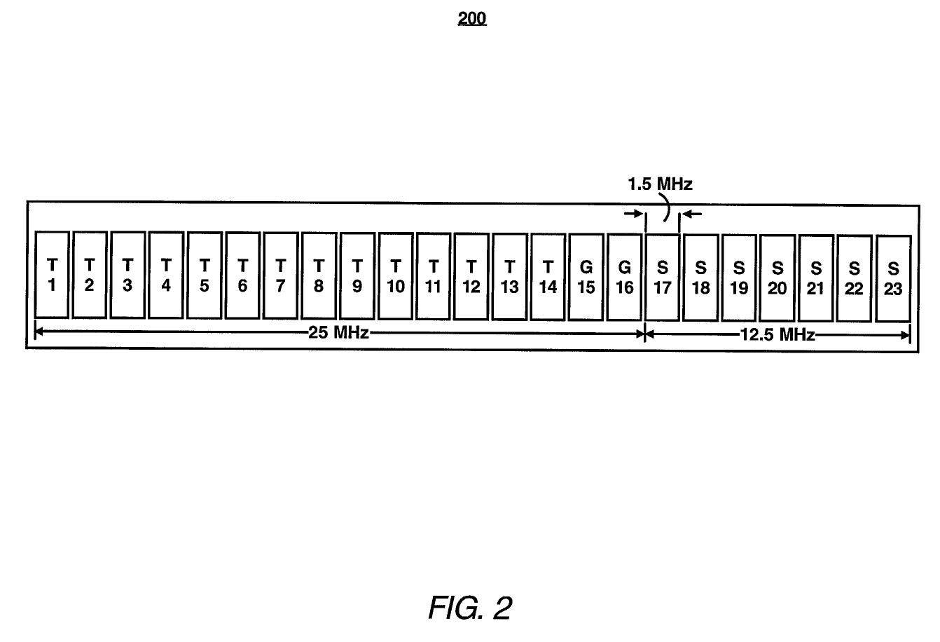

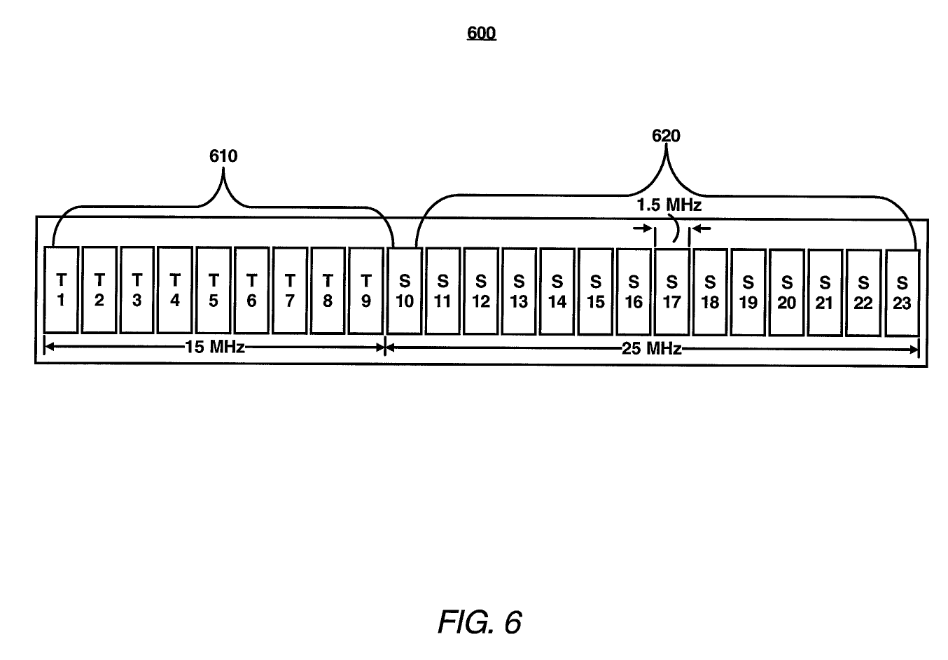

In another embodiment, the system 100 uses the DAB frequency spectrum 200 shown in FIG. 2 for transmitting DAB media content to coverage areas outside the United States. As described above with respect to FIG. 6, a 40 MHz frequency band (e.g., 1452-1492 MHz), divided into twenty-three frequency blocks is allocated for DAB worldwide, except for the United States.

As illustrated in FIG. 2, nine frequency blocks 15-23 may be used to transmit DAB media content to users. Blocks 15 and 16 are primarily used as guard bands, but they may also be used to transmit DAB media content. Blocks 15 and 16 may substantially be used locally by the repeaters in the system 100.

Using the frequency spectrum 200, a predetermined number of beams may be generated by the satellites 110-112 for providing an optimum number of channels for users of the system 100. For example, in one embodiment, two blocks of frequency may be carried on a wide-area beam (e.g., a “pan-European” or “multi-regions” beam) and five frequency blocks may be transmitted on separate beams to provide media content to several distinct coverage areas (e.g., seven distinct European beam-regions). Certain design parameters (e.g., power and satellite antenna design) may be selected in order to create appropriate frequency re-use distance between non adjacent “spot beams”.

FIG. 3 illustrates exemplary coverage areas 300 for a DAB system. For example, the satellites 110-112 generate seven beams over the European coverage area. One of the beams includes a European-wide beam that generates a European-wide footprint 310 (i.e., a wide-area coverage beam). The remaining six beams may generate footprints 311-316 (i.e., beam coverage areas) to provide coverage areas within a region (e.g. UK, France/Benelux, Germany, Italy, Iberia peninsula, Eastern Europe). An additional eighth beam may be added that generates a footprint 317 to provide regional media content to Scandinavian countries, such as Norway, Sweden, Finland and Denmark. The European-wide beam is a wide-area beam (i.e., a beam that has a wide-area coverage area larger than coverage areas for other beams, such as the regional beams, in the system 100).

The broadcast beam footprints 310-317 are designed to overlap with at least the wide-area footprint 310 and one or more of the remaining beam footprints 310-317. Furthermore, each of the beams providing beam footprints 310-317 may carry DAB media content that is directed to an associated region and that includes at least some DAB media content that is distinct from the media content provided by the European-wide beam. This allows for the broadcast of a maximum number of DAB channels into the most populated cities in Europe and to provide cross-cultural programming. The system 100 may support high quality digital channels of varying bandwidths for audio content (e.g., music and news/talk programming), as well as data channels for providing content ranging from simple text to advanced multimedia objects and software programs for downloads. In addition, within individual channels, sub-channels may be used to provide multi-lingual support and advanced multimedia capabilities which can support Telematics services (e.g., regional maps, tourism information regional updates, special local events, traffic alerts, etc.).

The bandwidth and quality of each individual channel may be adjusted from ground networks (including, for example, the repeaters 160 shown in FIG. 1), giving the capability to strategically place content where it is most valuable. By dynamically managing system resources, the services offered by the system 100 can be tailored to trade-off capacity and quality of service. Therefore, customer satisfaction may be maximized.

FIG. 3b is another illustration of the footprints 310-317 and further discloses the overlap of multiple coverage areas. As shown in both FIGS. 3a-b, a wide-area coverage area 310 is overlapped by multiple smaller-area coverage areas. This technique may provide the maximum amount and variety of programming to specific regional areas.

It will be apparent to one of ordinary skill in the art that the system 100 may be designed to provide coverage areas anywhere on Earth. Furthermore, the number of overlapping beams and the frequency spectrum used to transmit media content to users may vary by region, size of coverage area, etc.

The coverage area and media content provided by the system 100 can be optimized to meet market demand. To the extent this demand changes over time, the beam patterns and channel plans can be dynamically adjusted accordingly, by moving a beam or creating a new beam over another part of the coverage area without violating the frequency reuse requirements.

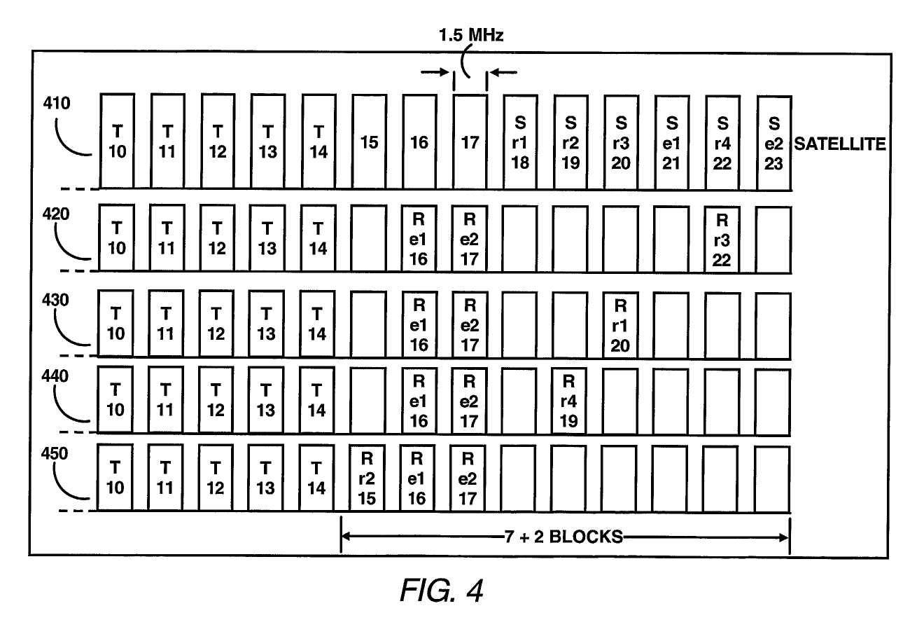

From a frequency allocation standpoint, each region is covered by at least two “blocks” of continental content and one frequency block of regional content. Allocation for both space segment and repeater segments (that fills satellites local gaps) of the coverage areas may be performed through extensive frequency re-use, both at the satellite and on the ground as shown in FIG. 4.

FIG. 4 illustrates frequency re-use for the satellites 110-112 and the repeaters 160. For example, a row 410 illustrates DAB media content r1-r4 and e1-e2 transmitted from the satellite 110 in the illustrated frequency blocks. Rows 420-450 illustrate the DAB media content transmitted from the repeaters 160 in the shown frequency blocks. Frequency blocks 15-23 are used to transmit the DAB media content.

The DAB media content r1 is transmitted from the satellite 110 in the frequency block 18, as shown in row 410. Then, r1 is transmitted by one of the repeaters 160 in the frequency block 20, as shown in the row 430. Therefore, frequency block 20, that was originally used to transmit r3 (row 410), is re-used in the repeater to transmit r1. Other frequency blocks are similarly re-used.

The one embodiment of the invention of the insertion may provide more than 190 unique channels of programming content distributed to regions across its European coverage area (210+ if using a regional beam for Scandinavia). At any given time and location within the coverage area, any subscriber may receive between 55 and 110 of these channels (76 channels average per user over the 15 main initial markets). Depending on the chosen beam configuration, some regions within the coverage area may have more channels than others.

Table 2 illustrates a comparison of the number of channels provided by the existing S-DAB systems and the system 100 providing the coverage area shown in FIG. 3. The system 100 significantly exceeds current total number of channels offered by conventional S-DAB systems. Although the system 100 may statistically offer less channels on average than the S-DAB service providers in the United States, which use a single beam coverage and a single language (with some Hispanic channels), a user of the system 100 traveling all over Europe potentially has access to almost twice as many channels. Also, Europe's linguistic and cultural diversity is well addressed within the channel assignment.

TABLE 2
Channels Generated From The System 100 vs. Conventional Systems

| | | | | | | | | | Average/ |
|---|---|---|---|---|---|---|---|---|---|
| | Beam 1 | Beam 2 | Beam 3 | Beam 4 | Beam 5 | Beam 6 | Beam 7 | Total | user |
| System | 28 | 27 | 27 | 27 | 27 | 27 | 27 | 190 | 74 |
| XM (U.S.) | 100 | | | | | | | 100 | 95 |
| SIRIUS (U.S.) | 100 | | | | | | | 100 | 100 |
| WorldSpace | 33 | 31 | 37 | | | | | 101 | 34 |
| (Mid-East, Africa, Asia | | | | | | | | | |

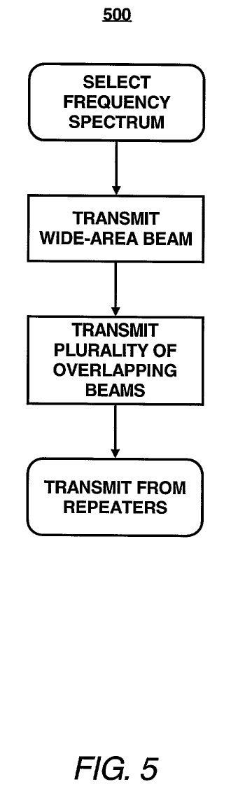

FIG. 5 illustrates an exemplary flow diagram 500 according to an embodiment of the invention. At step 510, a frequency spectrum is selected for transmitting media content from a satellite to users. In step 520, media content is transmitted on a wide-area beam in the selected frequency spectrum to a first region. The media content may include DAB media content. In step 530, media content is transmitted on a plurality of beams overlapping the wide-area beam from one or more satellites. The plurality beams may have footprints on distinct regions. Also, each of the plurality of beams may overlap with the wide-area beams. In step 540, repeaters may receive the media content from one or more of the beams and transmit the media content throughout a coverage area for the system. The coverage area may include coverage area for all the beams. Frequency reuse may be employed for satellite and repeater transmissions.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A digital audio broadcasting satellite system coverage area comprising:
a wide-area beam providing a wide-area coverage area; and
at least three beams, each of the at least three beams providing a coverage area overlapping the wide-area beam coverage area, wherein each of the three beams provides distinct media content to distinct regions within a system coverage area.

2. The system coverage area of claim 1, wherein the distinct media content includes media content different than the media content provided by the wide-area beam.

3. The system coverage area of claim 2, wherein the at least three beams comprises five beams, each providing a coverage area overlapping the wide-area beam.

4. The system coverage area of claim 2, wherein the at least three beams comprises six beams, each providing a coverage area overlapping the wide-area beam.

5. The system coverage area of claim 1, wherein the coverage area for each of the at least three beams overlaps the coverage area for at least one other beam of the at least three beams.

6. The system coverage area of claim 1, wherein a plurality of satellites traveling in highly elliptical orbits are used to generate the wide-area beam and the at least three beams.

7. The system coverage area of claim 1, wherein four or more frequency blocks, each having a bandwidth of approximately 1.5 MHz, are used by the wide-area beam and the at least three beams to transmit media content.

8. The system coverage area of claim 7, wherein a plurality of repeaters are used to transmit media content from the wide-area beam and the at least three beams to areas within the system coverage area.

9. The system coverage area of claim 8, wherein the repeaters, the wide-area beam and the at least three beams reuse frequencies within the four or more frequency blocks to transmit media content.

10. The system coverage area of claim 2, wherein the at least three beams comprises four beams, each providing a coverage area overlapping the wide-area beam.

11. The system coverage area of claim 2, wherein the at least three beams comprises seven beams, each providing a coverage area overlapping the wide-area beam.

12. The system coverage area of claim 2, wherein the at least three beams comprises eight beams, each providing a coverage area overlapping the wide-area beam.

13. A digital audio broadcasting satellite system having a system coverage area, the system comprising:
a plurality of satellites traveling in highly elliptical orbits, the plurality of satellites including at least one satellite transmitting a wide-area beam including media content, the wide-area beam providing a wide-area coverage area, and at least one satellite transmitting at least three beams, each of the at least three beams providing a coverage area overlapping the wide-area beam coverage area, wherein each of the three beams provides distinct media content to distinct regions within the system coverage area;
a plurality of repeaters receiving the media content from the plurality of satellites and transmitting the media content in the system coverage area; and
a plurality of receivers receiving the media content from one or more of at least one of the plurality of satellites and at least one of the plurality of repeaters.

14. The system of claim 13, wherein the plurality of satellites transmit the media content in a frequency spectrum having four or more frequency blocks, each having a bandwidth of approximately 1.5 MHz.

15. The system of claim 14, wherein the plurality of repeaters transmit the media content in the frequency spectrum.

16. The system of claim 15, wherein the plurality of satellites and the plurality of repeaters reuse frequencies within the frequency spectrum to transmit the media content.

17. The system of claim 13, wherein the at least three beams comprises five beams, each providing a coverage area overlapping the wide-area coverage area.

18. The system of claim 13, wherein the at least three beams comprises six beams, each providing a coverage area overlapping the wide-area beam.

19. The system of claim 13, wherein the at least three beams comprise four beams, each providing a coverage area overlapping the wide-area beam.

20. The system of claim 13, wherein the at least three beams comprise seven beams, each providing a coverage area overlapping the wide-area beam.

21. The system of claim 13, wherein the at least three beams comprise eight beams, each providing a coverage area overlapping the wide-area beam.

22. The system of claim 13, wherein the coverage area for each of the at least three beams overlaps the coverage area for at least one other beam of the at least three beams.

23. A method of generating a system coverage area for a digital audio broadcasting satellite system, the method comprising steps of:
selecting a frequency spectrum for transmitting media content from a plurality of satellites;
transmitting a wide-area beam providing a wide-area coverage area; and
transmitting at least three beams, each of the at least three beams providing a coverage area overlapping the wide-area beam coverage area, wherein each of the three beams provides distinct media content to distinct regions within the system coverage area.

24. The method of claim 23, wherein the system includes a plurality of repeaters and the method further comprises a step of transmitting in the selected frequency spectrum the media content received from the plurality of satellites from the plurality of repeaters.

25. The method of claim 24, further comprising reusing frequencies in the frequency spectrum for transmitting the media content.

26. The method of claim 23, wherein the frequency spectrum comprises four or more frequency blocks, each having a bandwidth of approximately 1.5 MHz.

27. A digital audio broadcasting satellite system comprising a plurality of satellites, wherein at least one of the plurality of satellites transmits a first wide-area beam providing media content to a first geographical area, and at least one of the plurality of satellites transmits at least two beams to a second and a third geographical area respectively, wherein the at least two beams provide media content distinct from the media content provided from the first beam, and the second and third geographical areas overlap the first geographical area.

28. The system of claim 27, wherein the media content provided by the first beam comprises general programming for digital audio broadcasting.

29. The system of claim 28, wherein the media content provided by the at least two beams comprises regional programming for digital audio broadcasting, the regional programming being associated with the second geographical area.

30. The system of claim 27, wherein each of the second and third geographical areas are smaller than the first geographical area.

31. The system of claim 27, wherein the at least two beams comprise at least six beams transmitting distinct media content to at least six distinct geographical areas, each of the at least six geographical areas overlapping the first geographical area.

32. The system of claim 27, wherein the at least two beams comprise four beams transmitting distinct media content to at least four distinct geographical areas, each of the four geographical areas overlapping the first geographical area.

33. The system of claim 27, wherein the at least two beams comprise five beams transmitting distinct media content to at least five distinct geographical areas, each of the five geographical areas overlapping the first geographical area.

34. The system of claim 27, wherein the at least two beams comprise seven beams transmitting distinct media content to at least seven distinct geographical areas, each of the seven geographical areas overlapping the first geographical area.

35. The system of claim 27, wherein the at least two beams comprise at least eight beams transmitting distinct media content to at least eight distinct geographical areas, each of the at least eight geographical areas overlapping the first geographical area.

36. A digital audio broadcasting satellite system coverage area comprising:
a wide-area beam providing a wide-area coverage area; and
at least two beams having coverage areas smaller than the wide-area beam, wherein each of the at least three beams provides a coverage area overlapping the wide-area beam coverage area, the overlapping coverage area receiving media content from each of the beams providing the overlapping coverage area;
wherein each of the three beams provides distinct media content to distinct regions within the system coverage area;
wherein the distinct media content includes media content different than the media content provided by the wide-area beam; and
wherein the coverage area for each of the at least three beams overlaps the coverage area for at least one other beam of the at least three beams.

37. The coverage area of claim 36, wherein a plurality of satellites traveling in highly elliptical orbits are used to generate the wide-area beam and the at least three beams.

38. The coverage area of claim 37, wherein four or more frequency blocks, each having a bandwidth of approximately 1.5 MHz, are used by the wide-area beam and the at least three beams to transmit the media content.

39. The coverage area of claim 37, wherein a plurality of repeaters are used to transmit media content from the wide-area beam and the at least three beams to areas within the system coverage area, and wherein
the repeaters, the wide-area beam and the at least three beams reuse frequencies within the four or more frequency blocks to transmit media content.

40. The coverage area of claim 36, wherein a plurality of receivers receive the media content from the wide area beam and the at least three beams.

41. The coverage area of claim 40, wherein a receiver of the plurality of receivers in the overlapping coverage area receives media content from each of the beams providing the overlapping coverage area.
